(19) United States
(12) Patent Application Publication
(10) Pub. No.: US 2022/0069522 A1
(43) Pub. Date: Mar. 3, 2022

(54) LEVER TYPE CONNECTOR

(71) Applicant: Yazaki Corporation, Tokyo (JP)

(72) Inventor: Yosuke AKAGI, Shizuoka (JP)

(73) Assignee: Yazaki Corporation, Tokyo (JP)

(21) Appl. No.: 17/459,345

(22) Filed: Aug. 27, 2021

(30) Foreign Application Priority Data
Aug. 28, 2020 (JP) 2020-144186

(51) Int. Cl. H01R 13/629; H01R 13/631; H01R 13/639

(52) U.S. Cl. CPC H01R 13/62955; H01R 13/639; H01R 13/631; H01R 13/62938

(57) ABSTRACT

A lever type connector includes a housing, and a lever having a pair of side plate portions and a connection portion. Shaft parts protrude on both side surfaces of the housing. The side plate portions have shaft hole parts. On an end portion of each of the shaft parts, a pair of projections arranged in non-point symmetry with respect to a circumferential direction of each of the shaft parts, is provided. Each of the shaft hole parts is provided with an insertion hole and regulations. The projections are inserted in each of the shaft hole parts through the insertion hole. The regulations are arranged to face the projections in a direction in which the side plate portions are away from both side surface of the housing, within a rotation range of the lever involved in fitting and removal of a mating housing and the housing.

### CROSS-REFERANCE TO RELATED APPLICATIONS

The present application is based on, and claims priority from Japanese Patent Application No. 2020-144186, filed on Aug. 28, 2020, the entire contents of which are incorporated herein by reference.

### TECHNICAL FIELD

The disclosure relates to a lever type connector.

### BACKGROUND

There has been known a conventional lever type connector including a housing and a lever (see Patent Document 1 (JP 2009-123530)). The housing is to be fitted with a mating housing. The lever is rotatably mounted to the housing. The housing is fitted with or removed from the mating housing by rotation of the lever.

In the lever type connector, the lever has a pair of side plate portions. The side plate portions are located outside both side surfaces of the housing, and have cam grooves in which cam pins on both side surfaces of the mating housing are engaged when the lever is rotated. The lever also has a connection portion that connects the side plate portions. On both side surfaces of the housing, support shafts as shaft parts are projected toward the side plate portions of the lever. The side plate portions have shaft receivers as shaft hole parts in which the support shafts are inserted to allow the lever to rotate with respect to the housing.

In the lever type connector, each of the support shafts is provided with a pair of locking pieces. The locking pieces are elastically deformable and arranged in point symmetry with respect to a circumferential direction of each support shaft. The locking pieces have tip flange parts, respectively. Each of the shaft receivers is provided with a step. The step is located such that the step faces the tip flange parts in a direction where the side plate portions are away from both side surfaces of the housing.

The tip flange parts are engaged to the step when the side plate portions of the lever are deformed in the direction where the side plate portions are away from both side surfaces of the housing. By the engagement of the tip flange parts and the step, the side plate portions of the lever are prevented from being away from both side surfaces of the housing, which holds the engagement of the cam pins of the mating housing and the cam grooves of the lever.

Each of the side plate portions of the lever has a regulation. The regulation can be moved between a deformation permission region and a deformation regulation region in accordance with the rotation of the lever. In the deformation permission region, the regulation does not interferes with the locking pieces to permit deformation of the locking pieces toward inside of the shaft receiver, which allows starting of mounting the lever to the housing. In the deformation regulation region, the regulation interferes with the locking pieces to regulate deformation of the locking pieces toward inside of the shaft receiver.

### SUMMARY

In a lever type connector such as the one in Patent Document 1, a structure that prevents the side plate portions of the lever from being away from each other, has an arrangement in point symmetry with respect to the circumferential direction of the shaft part. However, if the structure has the arrangement in point symmetry with respect to the circumferential direction of the shaft part, there is a possibility that the engagement of the tip flange parts and the step is disengaged while the lever is rotated 180 degrees from a position to start mounting the lever to the housing. Thus, a range in which the side plate portions of the lever can be prevented from being away from each other, is a maximum of 180 degrees in the circumferential direction of the shaft part.

Due to this, a range in which the lever can be rotated while the side plate portions of the lever are prevented from being away from each other, is limited to 180 degree at the maximum. This prevents the range in which the lever can be rotated, from being further increased. In addition, if the structure that prevents the side plate portions of the lever from being away from each other, has the arrangement in point symmetry, there is a possibility to mount the side plate portions of the lever to the housing in opposite directions, which results in incorrect mounting of the lever.

The disclosure has been made in view of such a conventional problem, and it is an object of the disclosure to provide a lever type connector that increases a range in which a lever can be rotated while side plate portions of the lever are prevented from being away from each other, and that prevents incorrect mounting of the lever.

According to an embodiment, a lever type connector including: a housing to be fitted with a mating housing; and a lever rotatably mounted to the housing, the housing being fitted with or removed from the mating housing by rotation of the lever, wherein the lever has a pair of side plate portions and a connection portion that connects the side plate portions, the side plate portions are located outside both side surfaces of the housing, and have cam grooves in which cam pins on both side surfaces of the mating housing are engaged when the lever is rotated, on both side surfaces of the housing, shaft parts protrude toward the side plate portions, the side plate portions have shaft hole parts in which the shaft parts are inserted to allow the lever to be rotated with respect to the housing, on an end portion of each of the shaft parts to be inserted in each of the shaft hole parts, a pair of projections arranged in non-point symmetry with respect to a circumferential direction of each of the shaft parts, is provided, each of the shaft hole parts is provided with an insertion hole and regulations, when the lever is started to be mounted to the housing, the projections are inserted in each of the shaft hole parts through the insertion hole, and the regulations are arranged to face the projections in a direction in which the side plate portions are away from both side surface of the housing, within a rotation range of the lever involved in fitting and removal of the mating housing and the housing.

According to an embodiment, the projections are inserted in each of the shaft hole parts through the insertion hole outside the rotation range of the lever involved in the fitting and removal of the mating housing and the housing.

According to the embodiment, it is possible to provide a lever type connector that increases a range in which a lever can be rotated while side plate portions of the lever are prevented from being away from each other, and that prevents incorrect mounting of the lever.

### BRIEF DESCRIPTION OF THE DRAWINGS

FIG. 1 is an exploded view of a lever type connector according to the embodiment.

FIG. 2 is a perspective view of the lever type connector according to the embodiment.

FIG. 3 is a side view of the lever type connector according to the embodiment.

FIG. 4 is a cross sectional view along a line IV-IV of FIG. 3

FIG. 5 is an enlarged view of a main part of FIG. 4.

FIG. 6 is a perspective view of a housing of the lever type connector according to the embodiment.

FIG. 7 is a side view of the housing of the lever type connector according to the embodiment.

FIG. 8 is a perspective view of a lever of the lever type connector according to the embodiment.

FIG. 9 is an enlarged view of a main part of FIG. 8.

FIG. 10 is a side view of the lever of the lever type connector according to the embodiment.

FIG. 11 is a top view of the lever of the lever type connector according to the embodiment when the lever is deformed.

FIG. 12 is a cross sectional view along a line XII-XII of FIG. 11.

FIG. 13 is an enlarged view of a main part of FIG. 12.

### DETAILED DESCRIPTION

Various embodiments will be described hereinafter with reference to the accompanying drawings. Note that the dimensional ratios in the drawings are exaggerated for convenience of explanation and may differ from the actual ratios.

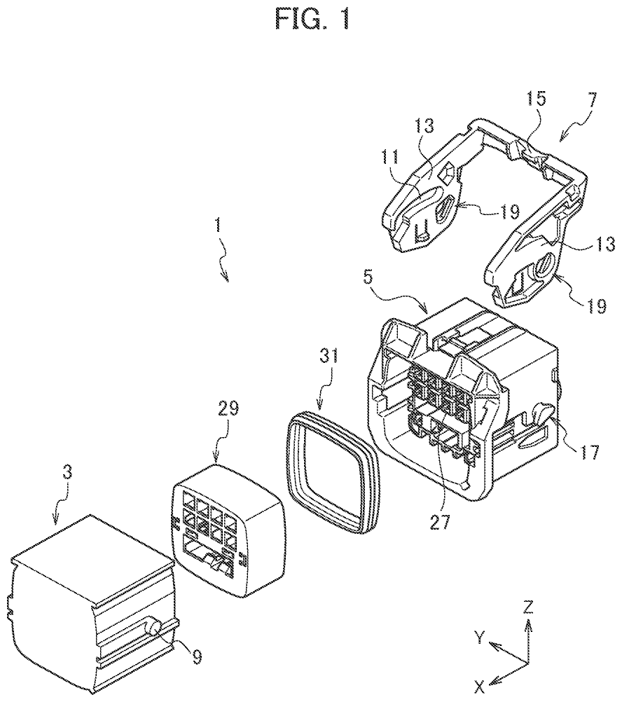

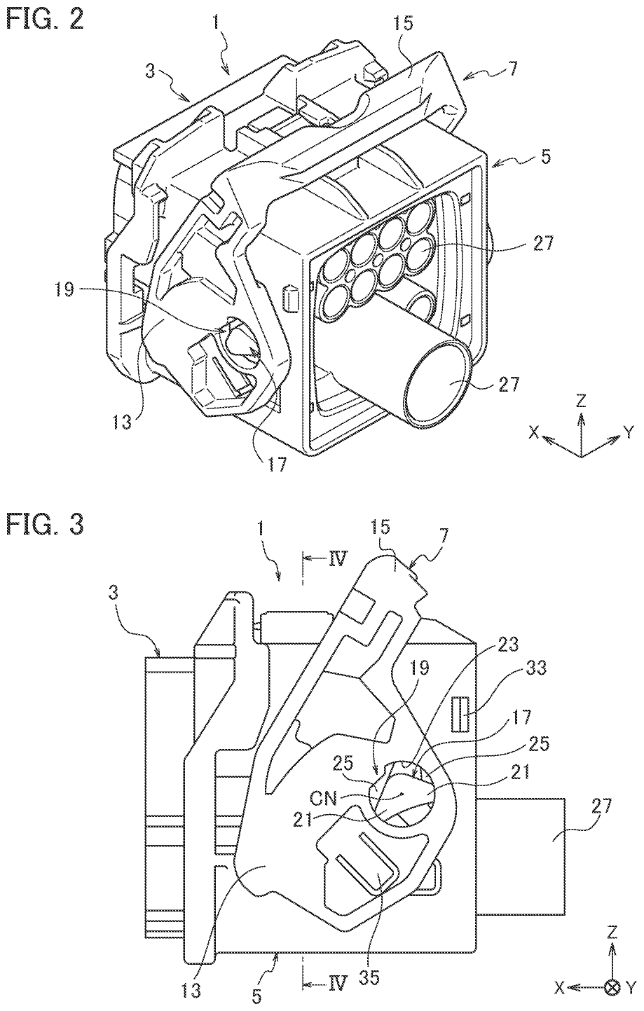

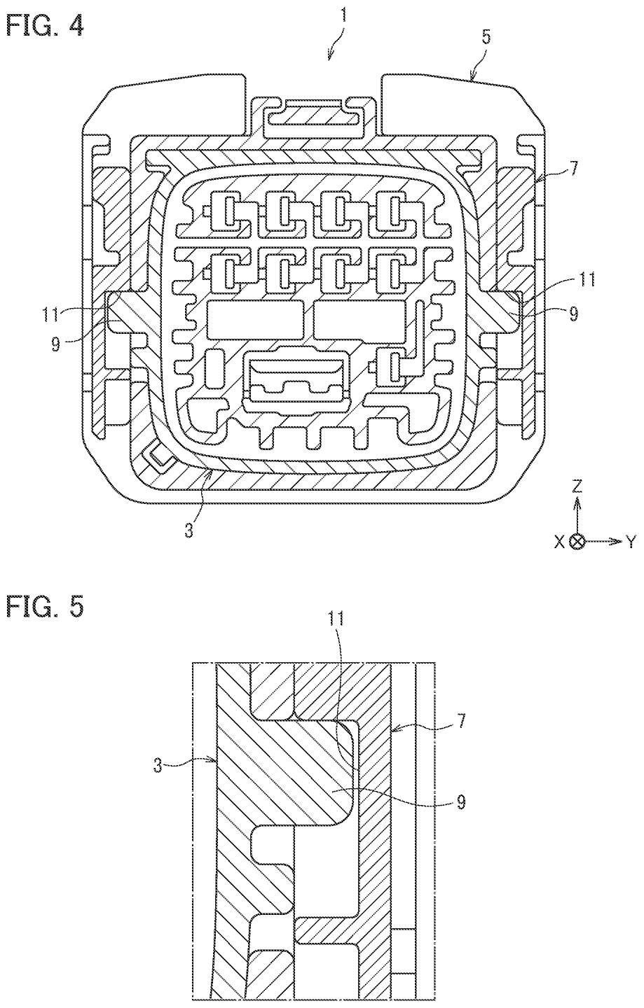

As illustrated in FIGS. 1 to 5, a lever type connector 1 according to the embodiment includes a housing 5 and a lever 7. The housing 5 is to be fitted with a mating housing 3. The lever 7 is rotatably mounted to the housing 5. The housing 5 is fitted with or removed from the mating housing 3 by rotation of the lever 7.

Note that an X-axis direction shown in each of FIGS. 1-4, 11 and 12 corresponds to a fitting direction (length direction) of the housing 5 in the lever type connector 1. A Y-axis direction shown in each of FIGS. 1-4, 11 and 12 corresponds to a width direction of the housing 5 in the lever type connector 1. A Z-axis direction shown in each of FIGS. 1-4, 11 and 12 corresponds to a height direction of the housing 5 in the lever type connector 1.

The lever 7 has a pair of side plate portions 13, 13. The side plate portions 13, 13 are located outside both side surfaces of the housing 5, and have cam grooves 11, 11 in which cam pins 9, 9 on both side surfaces of the mating housing 3 are engaged when the lever 7 is rotated. The lever 7 also has a connection portion 15 that connects the side plate portions 13, 13.

On both side surfaces of the housing 5, shaft parts 17, 17 protrude toward the side plate portions 13, 13 of the lever 7. That is, the shaft parts 17, 17 protrude in the width direction of the housing 5. Note that only one of the shaft parts 17, 17 is illustrated in the drawings. The side plate portions 13, 13 have shaft hole parts 19, 19 in which the shaft parts 17, 17 are inserted to allow the lever 7 to rotate with respect to the housing 5.

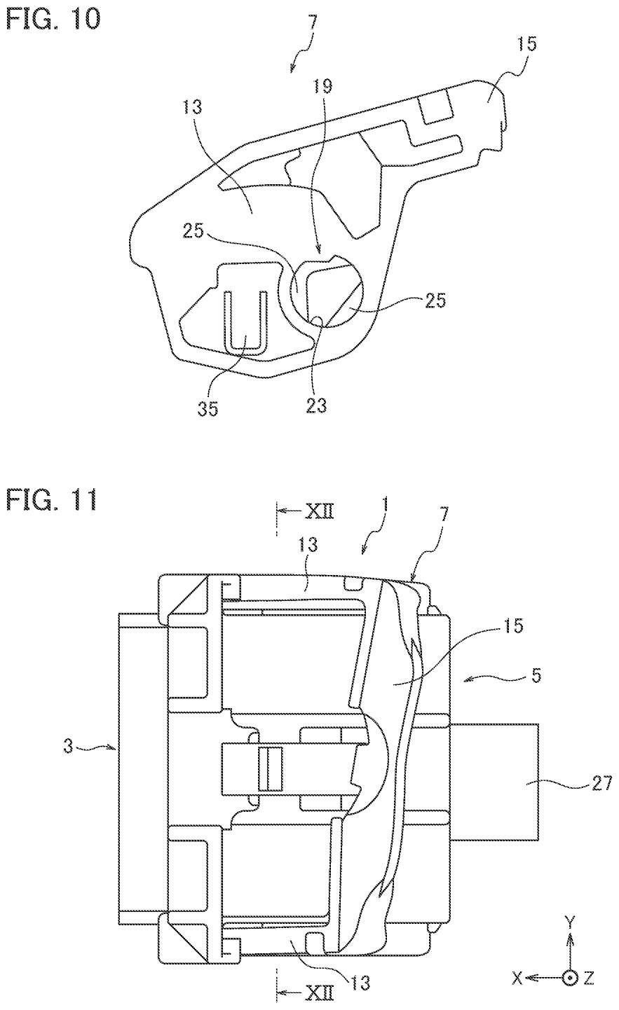

On an end portion of each shaft part 17 to be inserted in the corresponding shaft hole part 19, a pair of projections 21, 21 arranged in non-point symmetry with respect to the circumferential direction of the shaft part 17, is provided. The shaft hole parts 19, 19 are provided with insertion holes 23, 23, respectively. When the lever 7 is started to be mounted to the housing 5, the projections 21, 21 are inserted in the shaft hole parts 19, 19 through the insertion holes 23, 23. Each of the shaft hole parts 19, 19 is provided with regulations 25, 25 (see FIG. 10). The regulations 25, 25 are arranged to face the projections 21, 21 in a direction in which the side plate portions 13, 13 are away from both side surfaces of the housing 5. The regulations 25, 25 are arranged to face the projections 21, 21 within a rotation range of the lever 7 involved in the fitting and removal of the mating housing 3 and the housing 5.

The projections 21, 21 are inserted in the corresponding insertion hole 23 outside the rotation range of the lever 7 involved in the fitting and removal of the mating housing 3 and the housing 5.

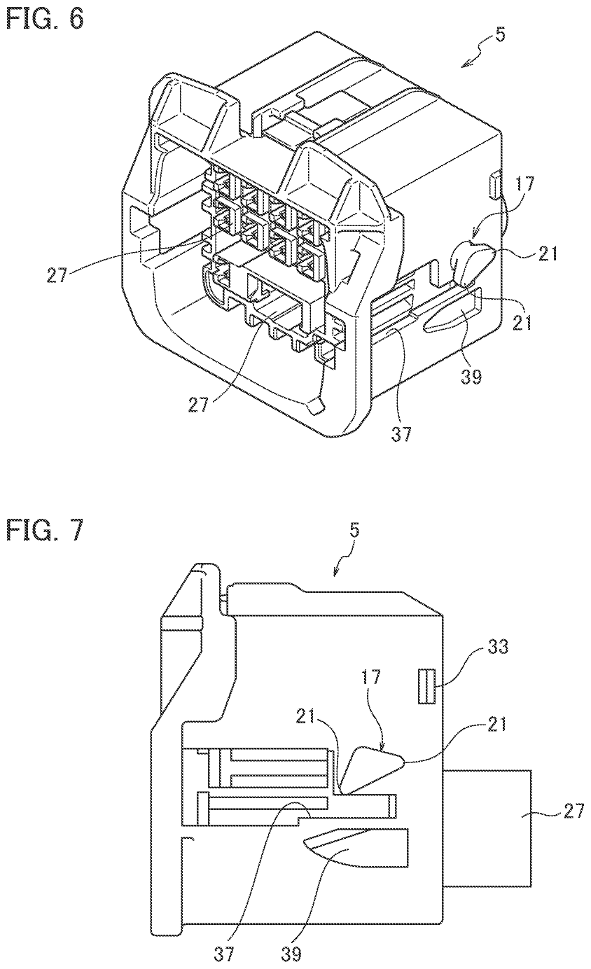

As illustrated in FIGS. 1 to 7, the housing 5 is made of an insulating material such as synthetic resin. The housing 5 is formed in a shape of an enclosure such that the mating housing 3 can be fitted in the housing 5, and has a plurality of terminal receiving chambers 27. The terminal receiving chambers 27 are extended inside the housing 5 in the fitting direction in which the housing 5 is to be fitted with the mating housing 3. The terminal receiving chambers 27 are provided in a plurality of rows in the width direction of the housing 5 and in a plurality of tiers in the height direction of the housing 5. Terminals (not illustrated) electrically connected to a power supply, a device, etc. are received within the terminal receiving chambers 27. The terminals are introduced in the terminal receiving chambers 27 through an opening of the housing 5 which is formed on a surface opposite to a fitting surface though which the housing 5 is to be fitted with the mating housing 3.

Locking lances (not illustrated) are provided in the terminal receiving chambers 27 to be connected to the introduced terminals. The locking lances prevent the terminals received in the terminal receiving chambers 27 from coming out of the opening of the housing 5 which is formed on the surface opposite to the fitting surface through which the housing 5 is to be fitted with the mating housing 3.

A front holder 29 is mounted in an opening of the housing 5 which is formed on the fitting surface through which the housing 5 is to be fitted with the mating housing 3. The front holder 29 prevents the terminals received in the terminal housing chambers 27 from protruding from the terminal receiving chambers 27. A packing 31 is mounted in the opening of the housing 5 which is formed on the fitting surface through which the housing 5 is to be fitted with the mating housing 3. When the housing 5 is fitted with the mating housing 3, the packing 31 adheres to the housing 5 and the mating housing 3 to waterproof a space between the housing 5 and the mating housing 3.

As illustrated in FIGS. 1 to 4, the mating housing 3 is made of an insulating material such as synthetic resin. The mating housing 3 is formed in a shape of an enclosure such that the mating housing 3 can be fitted in the housing 5. Mating terminals (not illustrated) electrically connected to a power supply, a device, etc. are received in the mating housing 3. When the mating housing 3 is fitted in the housing 5, the terminals are electrically connected to the mating terminals. The fitting and removal of the mating housing 3 and the housing 5 is performed by the rotation of the lever 7 rotatably mounted to the housing 5.

As illustrated in FIGS. 1 to 5 and FIGS. 8 to 10, the lever 7 is made of an insulating material such as synthetic resin. The lever 7 includes the pair of side plate portions 13, 13 and the connection portion 15 that connects the side plate portions 13, 13. The lever 7 is formed to have a width larger than one of the housing 5. The lever 7 is provided with the cam grooves 11, 11 and the shaft hole parts 19, 19.

The cam grooves 11, 11 are provided on inner surfaces of the side plate portions 13 and 13 of the lever 7, respectively. The cam grooves 11, 11 are open at a side of the fitting surface through which the housing 5 is to be fitted with the mating housing 3. When the housing 5 is started to be fitted with the mating housing 3, the cam pins 9, 9 protruding on both side surfaces of the mating housing 3, are inserted in the cam grooves 11, 11 through the openings, respectively. With the cam pins 9, 9 inserted in the cam grooves 11, 11, the lever 7 is rotated with respect to the housing 5.

The cam pins 9, 9 move along the cam grooves 11, 11 by the rotation of the lever 7, which causes the housing 5 to be fitted with the mating housing 3 such that the mating housing 3 is pulled into the housing 5. The fitting of the mating housing 3 and the housing 5 electrically connects the mating terminal to the terminal.

The shaft hole parts 19, 19 penetrate through the side plate portions 13 and 13 of the lever 7, respectively. The shaft pats 17, 17 protruding on both side surfaces of the housing 5, are inserted in the shaft hole parts 19, 19 to be engaged with the shaft hole parts 19, 19, respectively. By engaging the shaft parts 17, 17 with the shaft hole parts 19, 19, the lever 7 is rotatably mounted to the outer circumference of the housing 5.

The lever 7 is rotated between a rotation initial position and a rotation completion position in the fitting and removal of the mating housing 3 and the housing 5. The rotation initial position and the rotation completion position are held by housing protrusions 33, 33, initial grooves 37, 37 and completion grooves 39, 39 provided on the housing 5 and lever locking pieces 35, 35 provided on the lever 7. Note that only one of the housing protrusions 33, 33 is illustrated in the drawings. Only one of the initial grooves 37, 37 is illustrated in the drawings. Only one of the completion grooves 39, 39 is illustrated in the drawings.

As illustrated in FIGS. 3 and 7, the housing protrusions 33, 33 are provided on both side surfaces of the housing 5, respectively. In a state where the lever 7 is mounted to the housing 5, the housing protrusions 33, 33 protrude from both side surfaces of the housing 5 toward the lever 7 side. In the rotation initial position of lever 7, the housing protrusions 33, 33 are arranged to face side surfaces of the side plate portions 13, 13 of the lever 7. The housing projections 33, 33 are engaged with the side surfaces of the side plate portions 13, 13 of the lever 7 when the lever 7 starts to be rotated from the rotation initial position toward an opposite side of the rotation completion position. The engagement of the housing projections 33, 33 and the side plate portions 13, 13 regulates the rotation of the lever 7 from the rotation initial position toward the opposite side of the rotation completion position.

As illustrated in FIG. 3 and FIGS. 8 to 10, the lever locking pieces 35, 35 are flexibly provided on the side plate portions 13, 13 of the lever 7. The lever locking pieces 35, 35 has free ends protruding toward the housing 5 side in a state where the lever 7 is mounted to the housing 5. The lever locking pieces 35, 35 are engaged in the initial grooves 37, 37 at the rotation initial position of the lever 7, and are engaged in the completion grooves 39, 39 at the rotation completed position of the lever 7.

As illustrated in FIG. 7, the initial grooves 37, 37 are provided on both side surfaces of the housing 5. Each of the initial grooves 37, 37 penetrates through a side wall of the housing 5 and extends along the fitting direction in which the housing 5 is to be fitted with the mating housing 3. In the rotation initial position of the lever 7, each of the free ends of the lever locking pieces 35, 35 is engaged in each of the initial grooves 37, 37. The engagement of the lever locking pieces 35, 35 and the initial grooves 37, 37 regulates the rotation of the lever 7 due to an unexpected external force or the like from the rotation initial position toward the rotation completion position.

As illustrated in FIG. 7, the completion grooves 39, 39 are provided on both side surfaces of the housing 5. Each of the completion grooves 39, 39 is formed in a groove shape such that each of the free ends of the lever locking pieces 35, 35 is received in each of the completion grooves 39, 39 in the rotation completion position (see FIG. 3) of the lever 7. The free ends of the lever locking pieces 35, 35 are engaged with end portions of the completion grooves 39, 39 when the lever 7 starts to be rotated from the rotation completion position toward the rotation initial position. The engagement of the lever locking pieces 35, 35 and the completion grooves 39, 39 regulates the rotation of the lever 7 due to an unexpected external force or the like from the rotation completion position toward the rotation initial position. Note that in the rotation completion position of the lever 7, an engagement of the cam pins 9, 9 and bottom portions of the cam grooves 11, 11 regulates the rotation of the lever 7 from the rotation completion position toward the opposite side of the rotation initial position.

The lever 7 is held in the rotation initial position before the housing 5 is started to be fitted with the mating housing 3. The lever 7 held in the rotation initial position is rotated toward the rotation completion position by pressing the connecting portion 15 when the housing 5 is started to be fitted with the mating housing 3. The rotation of the lever 7 causes the lever locking pieces 35, 35 to flex such that the engagement of the lever locking pieces 35, 35 and the initial grooves 37, 37 is released.

Then, the cam pins 9, 9 move along the cam grooves 11, 11 by the rotation of the lever 7, which causes the housing 5 to be fitted with the mating housing 3 such that the mating housing 3 is pulled into the housing 5. The fitting of the mating housing 3 and the housing 5 electrically connects the mating terminal to the terminal. At this time, the lever 7 is rotated to the rotation completion position, and the lever locking pieces 35, 35 are engaged in the completion grooves 39, 39 to hold the rotational position of the lever 7.

On the other hand, when the housing 5 is started to be removed from the mating housing 3, the lever 7 is rotated from the rotation completed position toward the rotation initial position by pressing the connecting portion 15. The rotation of the lever 7 causes the lever locking pieces 35, 35 to flex such that the engagement of the lever locking pieces 35, 35 and the completion grooves 39, 39 is released.

Then, the cam pins 9, 9 move along the cam grooves 11, 11 by the rotation of the lever 7, which causes the housing 5 to be removed from the mating housing 3 such that the mating housing 3 is pushed away from the housing 5. The removal of the mating housing 3 and the housing 5 release the electrically connection of the mating terminal and the terminal. At this time, the lever 7 is rotated to the rotation initial position, and the lever locking pieces 35, 35 are engaged in the initial grooves 37, 37 to hold the rotational position of the lever 7.

In the rotation range of the lever 7 involved in the fitting and removal of the mating housing 3 and the housing 5, that is, between the rotation initial position and the rotation completion position, the cam pins 9, 9 of the mating housing 3 are engaged in the cam grooves 11, 11 of the lever 7. It is required that the engagement of the cam pins 9, 9 and the cam grooves 11, 11 is not released within the rotation range of the lever 7 between the rotation initial position and the rotation completion position.

However, if an external force is applied to the side plate portions 13, 13 of the lever 7 in a direction where the side plate portions 13, 13 are away from both side surfaces of the housing 5, the lever 7 is deformed such that the side plate portions 13, 13 are away from each other, as illustrated in FIG. 11, for example. In this case, there is a possibility that the engagement of the cam pins 9, 9 and the cam grooves 11, 11 is released. Therefore, in order to prevent the side plate portions 13, 13 of the lever 7 from being away from each other within the rotation range of the lever 7 between the rotation initial position and the rotation complete position, each of the shaft parts 17, 17 is provided with the projections 21, 21, and each of the shaft hole parts 19, 19 is provided with the insertion hole 23 and the regulations 25, 25.

As illustrated in FIGS. 3 and 7, the projections 21, 21 are provided on the end portion of each shaft part 17 to be inserted in the corresponding shaft hole part 19 and project outward in a radial direction of the shaft part 17. The projections 21, 21 are arranged in non-point symmetry with respect to the circumferential direction of the shaft part 17. That is, the projections 21, 21 are arranged such that a line connecting the projections 21, 21 does not pass through a center CN of the shaft part 17

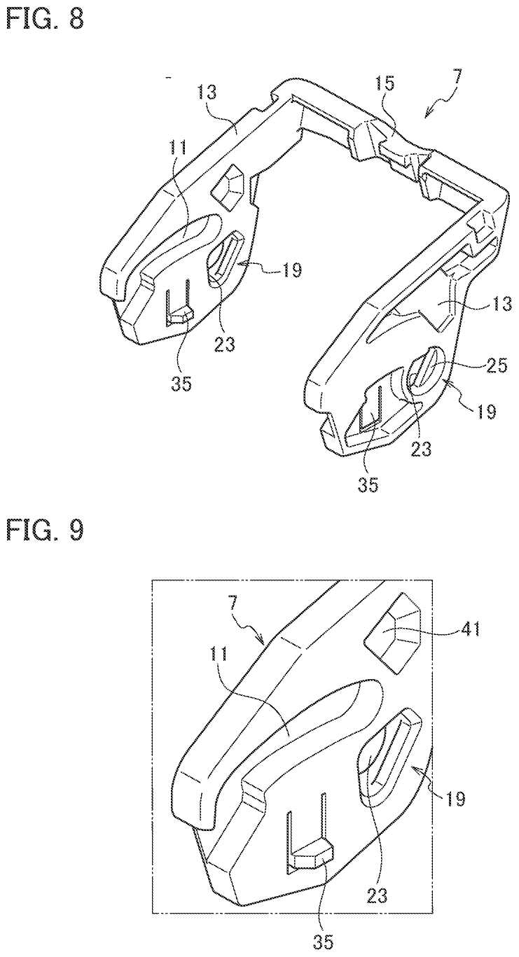

As illustrated in FIGS. 3 and 10, the insertion holes 23, 23 are provided on the inner circumferences of the shaft hole parts 19, 19. The insertion holes 23, 23 form openings of the shaft hole parts 19, 19 which are respectively located on inner surfaces of the side plate portions 13, 13 of the lever 7 (see FIG. 8).

An inner circumference shape of each of the insertion holes 23, 23 is formed to coincide with an outer circumference shape of the end portion of each shaft part 17 including the projections 21, 21, which allows the end portion of each shaft part 17 to be inserted in the corresponding shaft hole part 19 through the corresponding insertion hole 23. The inner circumference shape of the insertion hole 23 is set so that the inner circumference shape coincides with the outer circumference shape of the end portion of each shaft part 17, outside the rotation range of the lever 7 involved in the fitting and removal of the mating housing 3 and the housing 5.

That is, each of the insertion holes 23, 23 is set such that the end portion of the shaft part 17 including the projections 21, 21 can be inserted in the corresponding shaft hole part 19 through the corresponding insertion hole 23, at a rotation position of the lever 7 where the lever 7 is located at an opposite side of the rotation completion position with respect to the rotation initial position, or at a rotation position of the lever 7 where the lever is located at an opposite side of the rotation initial position with respect to the rotation completion position. In this embodiment, each of the insertion holes 23, 23 is set such that the end portion of the shaft part 17 including the projections 21, 21 can be inserted in the corresponding shaft hole part 19 through the corresponding insertion hole 23, at the rotation position of the lever 7 where the lever is located at the opposite side of the rotation completion position with respect to the rotation initial position.

By setting the insertion holes 23, 23 in such a manner, the lever 7 can be mounted to the housing 5 outside the rotation range of the lever 7 involved in the fitting and removal of the mating housing 3 and the housing 5. That is, the lever 7 can be mounted to the housing 5 in the range that is not involved in the engagement of the cam pins 9, 9 and the cam grooves 11, 11. Therefore, when the cam pins 9, 9 are engaged in the cam grooves 11, 11, each insertion hole 23 and the corresponding projections 21, 21 do not coincide with each other, that is do not fully face each other. This prevents the shaft parts 17, 17 from coming off the shaft hole parts 19, 19, which prevents the side plate portions 13, 13 of the lever 7 from being away from each other.

When the projections 21, 21 are arranged in point symmetry with respect to the circumferential direction of the shaft part 17, the inner circumferential shape of each insertion hole 23 is also formed in point symmetry with respect to the circumferential direction of the shaft hole part 19. If the projections 21, 21 are formed in point symmetry and the inner circumferential shape of the corresponding insertion hole 23 are formed in point symmetry, the projections 21, 21 can be inserted into the corresponding insertion hole 23 even when the side plate portions 13, 13 are upside down. This may cause the lever 7 to be incorrectly mounted to the housing 5.

In this embodiment, since the projections 21, 21 are formed in non-point symmetry and the inner circumferential shape of the corresponding insertion hole 23 are formed in non-point symmetry, the projections 21, 21 cannot be inserted into the insertion hole 23 when the side plate portions 13, 13 are upside down. This prevents incorrect mounting of the lever 7 to the housing 5.

In the rotational position of the lever 7 where the projections 21, 21 face the corresponding insertion hole 23, the rotational position of the lever 7 is held by an engagement of lever recesses 41, 41 (see FIG. 9), which are provided on the inner surface of the side plate portions 13, 13 of the lever 7, and the housing projections 33, 33. Note that only one of the lever recesses 41, 41 is illustrated in the drawings.

As illustrated in FIGS. 3 and 10, the regulations 25, 25 are provided on the inner circumference of each shaft hole part 19 and protrude inward in a radial direction of each shaft hole part 19. The regulations 25, 25 are formed to connect the outer circumference of the insertion hole 23 with the inner circumference of the shaft hole part 19, and are arranged in non-point symmetry with respect to the circumferential direction of each shaft hole part 19. The regulations 25, 25 are arranged to face the projections 21, 21 in the direction in which the side plate portions 13, 13 are away from both side surfaces of the housing 5, within the rotation range of the lever 7 involved in the fitting and removal of the mating housing 3 and the housing 5.

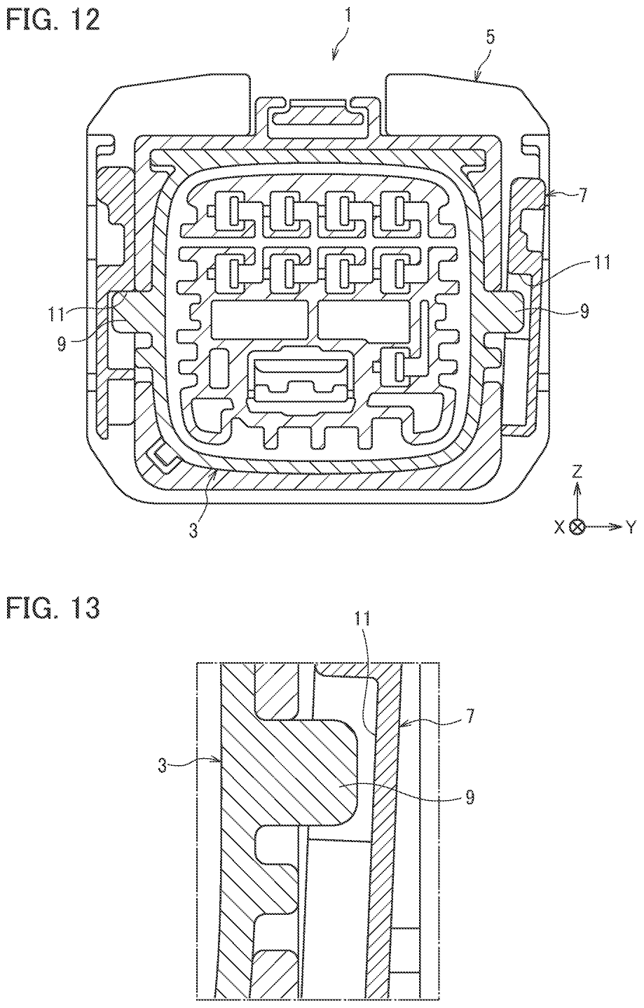

Therefore, the regulations 25, 25 are engaged with the projections 21, 21 when one of the side plate portions 13,13 is deformed in the direction in which the one of the side plate portions 13, 13 is away from the side surface of the housing 5 (see FIG. 11) within the rotation range of the lever 7 between the rotation initial position and the rotation completion position. The engagement of the projections 21, 21 and the regulations 25, 25 can regulate the one of the side plates 13, 13 from being away from the side surface of the housing 5, and prevent the side plate portions 13, 13 of the lever 7 from being away from each other. Therefore, as illustrated in FIGS. 12 and 13, when the cam pins 9, 9 are engaged in the cam grooves 11, 11, the side plate portions 13, 13 of the lever 7 can be prevented from being away from each other. This stably maintains the engagement between the cam pins 9, 9 and the cam grooves 11, 11.

When the projections 21, 21 are arranged in point symmetry with respect to the circumferential direction of the shaft part 17, the regulations 25, 25 are also arranged in point symmetry with respect to the circumferential direction of the shaft hole part 19. If the projections 21, 21 are arranged in point symmetry and the regulatory portions 25, 25 are arranged in point symmetry, the projections 21, 21 coincide with (fully face) the insertion hole 23 when the lever 7 is rotated 180 degrees from a position to start mounting the lever 7 to the housing 5. Therefore, if the projections 21,21 are arranged in point symmetry and the regulations 25,25 are arranged in point symmetry, a range in which the lever 7 can be rotated while preventing the side plate portions 13, 13 of the lever 7 from being away from each other, is limited to a range of 180 degrees at most.

In contrast, when the projections 21, 21 are arranged in non-point symmetry and the regulating portions 25, 25 are arranged in non-point symmetry, the projections 21, 21 do not coincide with (fully face) the insertion hole 23 unless the lever 7 is rotated 360 degrees from the position to start mounting the lever 7 to the housing 5. Therefore, the range in which the lever 7 can be rotated while preventing the side plate portions 13, 13 of the lever 7 from being away from each other, can be increased.

Note that one of the projections 21, 21 may be placed in the insertion hole 23 when the lever 7 is rotated. However, the other of the projections 21, 21 is engaged with the corresponding regulations 25, 25 when the lever is not in the position to start mounting the lever 7 to the housing 5. Therefore, the separating of the side plate portions 13, 13 of the lever 7 can be prevented in a wide range of rotation of the lever 7.

In the lever type connector 1, a pair of projections 21, 21 arranged in non-point symmetry with respect to the circumferential direction of the shaft part 17 is provided on the end portion of the shaft part 17 to be inserted in the shaft hole part 19. The shaft hole part 19 is provided with the insertion hole 23 through which the projections 21, 21 is inserted in the shaft hole part 19 when the lever 7 is started to be mounted to the housing 5. Further, the shaft hole part 19 is provided with the regulations 25, 25 which are arranged to face the projections 21, 21 in a direction in which the side plate portions 13, 13 are away from both side surfaces of the housing 5. The regulations 25, 25 are arranged to face the projections 21, 21 within the rotation range of the lever 7, involved in the fitting and removal of the mating housing 3 and the housing 5.

With this configuration, the projections 21, 21 are arranged in non-point symmetry with respect to the circumferential direction of the shaft part 17, and the insertion hole 23 is arranged in non-point symmetry and the regulations 25, 25 are arranged in non-point symmetry with respect to the circumferential direction of the shaft hole part 19. Therefore, the projections 21, 21 do not coincide with the insertion hole 23, that is, the projections 21,21 do not fully face the insertion hole 23, unless the lever 7 is rotated 360 degrees from the position to start mounting the lever 7 to the housing 5.

Within the rotation range of the lever 7 in which the projections 21, 21 do not coincide with (fully face) the insertion hole 23, the projections 21, 21 are arranged to face the regulations 25, 25 in the direction in which the side plate portions 13, 13 are away from both side surfaces of the housing 5. Therefore, the separating of the side plate portions 13, 13 of the lever 7 can be prevented by the engagement of the projections 21,21 and the regulations 25, 25, and the range in which the lever 7 can be rotated while preventing the side plate portions 13, 13 of the lever 7 from being away from each other, can be increased.

The projections 21, 21 are arranged in non-point symmetry, and the insertion hole 23 is arranged in non-point symmetry. Therefore, the projections 21,21 cannot be inserted into the insertion hole 23 when the side plate portions 13,13 are upside down. This prevents incorrect mounting of the lever 7 to the housing 5.

Therefore, the lever-type connector 1 can increase the range in which the lever 7 can be rotated while preventing the side plate portions 13, 13 of the lever 7 from being away from each other, and prevent incorrect mounting of the lever 7.

The projections 21, 21 are inserted the insertion hole 23 outside the rotation range of the lever 7 involved in the fitting and removal of the mating housing 3 and housing 5. Therefore, the lever 7 can be mounted to the housing 5 in the range not involved in the engagement of the cam pins 9, 9 and the cam grooves 11, 11. Thus, when the cam pins 9, 9 are engaged in the cam grooves 11, 11, the projections 21, 21 do not coincide with (fully face) the insertion hole 23, which prevents the side plate portions 13, 13 of the lever 7 from being away from each other.

The embodiments described above are not limited to these, but various modifications are possible within the scope of the gist of the embodiments.

For example, the projections 21, 21 are inserted into the insertion hole 23 at the rotation position of the lever 7 where the lever 7 is located at the opposite side of the rotation completion position with respect to the rotation initial position, but it is not limited thereto. For example, the projections 21, 21 may be inserted into the insertion hole 23 at the rotation position of the lever 7 where the lever 7 is located at the opposite side of the rotation initial position with respect to the rotation completion position.

In the lever type connector 1, the rotation range of the lever 7 involved in the fitting and removal the mating housing 3 and the housing 5 is about 90 degrees, but it is not limited hereto. For example, if a lager rotation space for the lever 7 can be set around the lever type connector 1, the rotation range of the lever 7 involved in the fitting and removal of the mating housing 3 and the housing 5 may be increased. Even when the rotation range of the lever 7 is increased in this way, the lever type connector 1 can prevent the side plate portions 13, 13 of the lever 7 from being away from each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lever type connector comprising:
a housing to be fitted with a mating housing; and
a lever rotatably mounted to the housing, the housing being fitted with or removed from the mating housing by rotation of the lever;
wherein
the lever has a pair of side plate portions and a connection portion that connects the side plate portions,
the side plate portions are located outside both side surfaces of the housing, and have cam grooves in which cam pins on both side surfaces of the mating housing are engaged when the lever is rotated,
on both side surfaces of the housing, shaft parts protrude toward the side plate portions,
the side plate portions have shaft hole parts in which the shaft parts are inserted to allow the lever to be rotated with respect to the housing,
on an end portion of each of the shaft parts to be inserted in each of the shaft hole parts, a pair of projections arranged in non-point symmetry with respect to a circumferential direction of each of the shaft parts, is provided,
each of the shaft hole parts is provided with an insertion hole and regulations,
when the lever is started to be mounted to the housing, the projections are inserted in each of the shaft hole parts through the insertion hole, and
the regulations are arranged to face the projections in a direction in which the side plate portions are away from both side surface of the housing, within a rotation range of the lever involved in fitting and removal of the mating housing and the housing.

2. The lever type connector according to claim 1, wherein
the projections are inserted in each of the shaft hole parts through the insertion hole outside the rotation range of the lever involved in the fitting and removal of the mating housing and the housing.
